(19) United States
(12) Patent Application Publication
(10) Pub. No.: US 2016/0036772 A1
(43) Pub. Date: Feb. 4, 2016

(54) Technique to Prevent IPv6 Address Exhaustion in Prefix Delegation Mode for Mobile Access Point Routers

(71) Applicant: QUALCOMM Incorporated, San Diego, CA (US)

(72) Inventors: Chaitanya Pratapa, Hyderabad (IN); Rohit Tripathi, San Diego, CA (US); Gaurav Gopal Kathuria, San Diego, CA (US); Tyler Byron Wear, San Diego, CA (US)

(21) Appl. No.: 14/558,854

(22) Filed: Dec. 3, 2014

(30) Foreign Application Priority Data
Jul. 31, 2014 (IN) 3746/CHE/2014

(51) Int. Cl. H04L 29/12; H04L 12/28

(52) U.S. Cl. CPC H04L 61/2061; H04L 12/2854; H04L 61/2038

(57) ABSTRACT

Methods, devices, systems, and non-transitory process-readable storage media include methods for preventing IPv6 address exhaustion in prefix delegation mode by a software-enabled access point (“softAP”) mobile computing device providing an Internet Protocol version 6 (IPv6) wide area network (WAN) connection to a plurality of client devices. A processor of a softAP mobile computing device may include assigning an unassigned prefix of a pool of available prefixes to a client device connected to a local area network (LAN) established by the softAP mobile computing device. The processor may determine whether the client device is disconnected from the LAN based on receiving an indication that the client device has disconnected. The processor may perform a cache look-up to obtain a link-local address of the client device when the client device is disconnected from the LAN, and unassign the prefix associated with the link-local address of the client device.

### RELATED APPLICATIONS

The present application claims priority to Indian Application No. 3746/CHE/2014, entitled “Technique to Prevent IPv6 Address Exhaustion in Prefix Delegation Mode for Mobile Access Point Routers” filed Jul. 31, 2014, the entire contents of which are hereby incorporated by reference.

### BACKGROUND

Numerous techniques and protocols are utilized to enable computing devices to connect to and communicate over packet-switching, wide area networks (WANs). For example, Internet Protocol version 4 (IPv4) and Internet Protocol version 6 (IPv6) may be used to enable devices to exchange packet data over the Internet. For the IPv6 protocol, devices may connect to a WAN using 128-bit addresses that include unique prefixes that are typically 64-bit in length and that are administered by a network entity. In common scenarios, a router device (e.g., a Wi-Fi® router, a software-enabled access point (“softAP”) device, etc.) receiving such a prefix via its modem may share the same prefix with all client devices connected to a local area network (LAN) established by the router device such that all traffic to the WAN from the router device includes the same prefix. For example, LAN client devices connected to the router device may combine the shared prefix with a unique identifier (e.g., a MAC address, etc.) in order to generate their IPv6 address for packet transmissions. Such uniformity of prefix may be problematic for network carriers and other entities that desire to accurately identify different devices using the WAN and to bill based on usage. Further, although some duplicate address detection processes may be executed when LAN client devices generate their IPv6 address using a shared prefix, other LAN client devices may have the same address, causing redundancies in IPv6 addresses.

Some router devices (or packet data network (PDN) connections) may be configured to utilize a “prefix delegation” feature, such as described by the 3rd Generation Partnership Project (3GPP) (e.g., within the standards document 3GPP TS 23.060 V10.4.0). Implementing such a feature, a router device may obtain (via its modem) a single network prefix that is shorter than the default prefix size (e.g., 64-bit or /64). For example, the router device may obtain a short prefix 56-bit in size (or /56). The router device may allocate unique prefixes (e.g., 64-bit in length) used for IPv6 stateless auto-configuration using the bits that are not used in the short prefix (e.g., 56-bit in length, etc.), allowing a certain number of LAN client devices to all have unique prefixes. For example, when the default prefix is 64-bit long and the prefix delegation router device obtains a short prefix that is 56-bit long, the router device may utilize 8-bits to generate a fixed number of 64-bit unique prefixes based on the short prefix. Each of the generated the 64-bit unique prefixes may then be assigned to different client devices connected to the router device (e.g., via a LAN connection). The router device may generate and assign 64-bit length unique prefixes upon request from connected LAN client devices. In this way, the remaining address space from the short prefix can be delegated to the router device (or PDN connection) using prefix delegation, so that the router device may provide on request a certain number of LAN client devices unique IPv6 addresses that fit into the total available IPv6 address space.

Prefix delegation is often utilized by some router devices. For example, a main use of prefix delegation is typically for a service provider to assign a prefix to a customer-provided equipment (CPE) device acting as a router between a subscriber's internal network and the service provider's core network. This may be useful for companies which need a large address space.

Prefix exhaustion can be a problem because the number of LAN client devices that can be supported by the router device using the prefix delegation feature is capped at the finite amount of unique 64-bit prefixes that can be generated from the short prefix (e.g., 56-bit or /56). For example, LAN client devices connecting to the router device via wireless connections (e.g., Wi-Fi®) or wired connections (e.g., universal serial bus (USB)) may use the stateless address configuration (i.e., send the router device a solicitation message) to cause the router device's modem to assign a unique prefix. When such LAN client devices with assigned IPv6 addresses disconnect from the router device (e.g., get disconnected, dropped, etc.), their assigned IPv6 unique prefixes may not get flushed until the router device drops the IPv6 WAN connection. This differs from the IPv4 protocol in which disconnecting LAN client devices can send “DHCP RELEASE” messages to cause the router device to release their assigned IPv4 addresses. The failure to flush released IPv6 addresses may prevent new LAN client devices from being able to obtain IPv6 addresses due to the limited number of addresses available. For example, prefix exhaustion may occur when LAN client devices accessing an IPv6 backhaul via a router device frequently connect to and disconnect from the LAN without the router device rebooting or otherwise disconnecting from its WAN connection regularly.

### SUMMARY

Various embodiments provide methods, devices, systems, and non-transitory process-readable storage media for preventing IPv6 address exhaustion in prefix delegation mode by a software-enabled access point (“softAP”) mobile computing device providing an Internet Protocol version 6 (IPv6) wide area network (WAN) connection to a plurality of client devices. An embodiment method performed by at least one processor of a softAP mobile computing device may include assigning an unassigned prefix of a pool of available prefixes to a client device connected to a local area network (LAN) established by the softAP mobile computing device, determining whether the client device is disconnected from the LAN based on receiving an indication that the client device has disconnected, performing a look-up on a cache to obtain a link-local address of the client device in response to determining that the client device is disconnected from the LAN, and unassigning the prefix associated with the link-local address of the client device. In some embodiments, the method may further include establishing the IPv6 WAN connection in which the softAP mobile computing device receives a short prefix from a network resource, and the pool of available prefixes may be based on the short prefix. In some embodiments, the method may further include routing traffic between the WAN and the client device using the prefix when the client device is connected to the LAN.

In some embodiments, the indication may be one of a kernel event and a hostapd user space daemon event, and the indication may include at least one of a media access control (MAC) address and an IP address. In some embodiments, the hostapd user space daemon event may be an “AP-STA-DISCONNECTED” event, and the client device may be connected to the LAN via a wireless connection. In some embodiments, the kernel event may be an “RTM_DELLINK” kernel event, and the client device may be connected to the LAN via a universal serial bus (USB) connection. In some embodiments, the kernel event may be an “RTM_DELNEIGH” kernel event, and the client device may be connected to the LAN via a universal serial bus (USB) connection or a wireless connection.

In some embodiments, the method may further include identifying the client device to be connected to the IPv6 WAN connection based on a received indication. In some embodiments, the received indication may be an “AP-STA-CONNECTED” event, and the client device may be requesting to connect to the LAN via a wireless connection. In some embodiments, the received indication may be an “RTM_NEWLINK” kernel event, and the client device may be requesting to connect to the LAN via a universal serial bus (USB) connection. In some embodiments, the received indication may be an “RTM_NEWNEIGH” kernel event, and the client device may be requesting to connect to the LAN via a universal serial bus (USB) connection or a wireless connection.

In some embodiments, the look-up may be performed via an application processor of the softAP mobile computing device and the operation of unassigning may be performed via one of the application processor and a modem processor of the softAP mobile computing device. In some embodiments, the method may further include transmitting a message from the application processor to the modem processor indicating that the prefix is to be unassigned in response to performing the look-up, in which unassigning the prefix associated with the link-local address of the client device may include unassigning the prefix in response to receiving the message from the application processor. In some embodiments, determining whether the client device is disconnected from the LAN may include determining whether a timer has elapsed, and testing whether the client device is disconnected in response to determining that the timer has elapsed.

In some embodiments, the method may further include identifying a privileged client device to be connected to the IPv6 WAN connection based on stored data indicating privileged client devices, determining whether there is at least one unassigned prefix in the pool of available prefixes, determining whether a non-privileged client device has an assigned second prefix in response to determining that there are no unassigned prefixes in the pool of available prefixes, unassigning the assigned second prefix in response to determining that the non-privileged client device has the assigned second prefix, and assigning the assigned second prefix to the privileged client device. In some embodiments, the stored data indicating the privileged client devices may be one or more of a list of media access control (MAC) addresses of the privileged client devices and a service set identifier (SSID) used by the privileged client devices. In some embodiments, the method may further include adding the identified privileged client device to a priority waiting list in response to determining that all prefixes are assigned to other devices indicated by the stored data indicating the privileged client devices, removing the identified privileged client device from the priority waiting list in response to unassigning one of the pool of available prefixes, and assigning one of the pool of available prefixes to the identified privileged client device.

Further embodiments include a mobile computing device configured with processor-executable instructions for performing operations of the methods described above. Further embodiments include a non-transitory processor-readable medium on which is stored processor-executable instructions configured to cause a mobile computing device to perform operations of the methods described above. Further embodiments include a communication system including a mobile computing device configured with processor-executable instructions to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a communication system including a mobile computing device functioning as a software-enabled access point (or mobile router) for various devices according to various embodiments.

FIG. 2A is a component block diagram of modules within a mobile computing device configured to operate as a software-enabled access point (or mobile router) suitable for use in various embodiments.

FIG. 2B is a component block diagram of modules within a mobile computing device configured to operate as a software-enabled access point (or mobile router) suitable for use in various embodiments.

FIG. 3 is a process flow diagram illustrating an embodiment method for a mobile computing device configured to operate as a software-enabled access point (or mobile router) to unassign prefixes in response to the disconnection of client devices from a local area network (LAN) connection.

FIG. 4 is a process flow diagram illustrating another embodiment method for a mobile computing device configured to operate as a software-enabled access point (or mobile router) to unassign prefixes in response to the disconnection of client devices from a local area network (LAN) connection.

FIG. 5 is a process flow diagram illustrating another embodiment method for a mobile computing device configured to operate as a software-enabled access point (or mobile router) to unassign prefixes based on priority information and in response to the disconnection of client devices from a LAN connection.

FIG. 6 is a component block diagram of a mobile computing device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile computing device” and “computing device” are used herein to refer to any one or all of cellular telephones, smart-phones, web-pads, tablet computers, Internet enabled cellular telephones, Wi-Fi® enabled electronic devices, personal data assistants (PDA's), laptop computers, personal computers, and similar electronic devices equipped with at least a processor and configured with a network transceiver to establish a wide area network (WAN) and/or a local area network (LAN) connection (e.g., an LTE, 3G or 4G wireless wide area network transceiver, a wired connection to the Internet, or Wi-Fi®).

The terms “software-enabled access point mobile computing device” or “softAP mobile computing device” or “mobile access point router” are used herein to refer to mobile computing devices configured to execute various software, applications, routines, instructions, and/or operations for operating as routers capable of establishing WAN connections and LAN connections for enabling other devices to communicate with the WAN. For example, a softAP mobile computing device may be a smartphone configured to operate as a wireless router (e.g., mobile Wi-Fi® router) for providing other devices access to a cellular wide area network. The terms “client device” and “LAN client device” and “WLAN client device” are used interchangeably herein to refer to devices that may connect to LAN connections established by softAP mobile computing devices. For example, client devices may include smartphones that are connected to a softAP mobile computing device in order to access the Internet.

The embodiment techniques described herein may utilize various wireless communication networks having such standards and/or protocols as Code division multiple access (CDMA), Time division multiple access (TDMA), Frequency Division Multiple Access (FDMA), Orthogonal Frequency-Division Multiple Access (OFDMA), etc. A CDMA network may implement a radio technology such as Universal Terrestrial Radio Access (UTRA), cdma2000, etc. UTRA includes Wideband-CDMA (W-CDMA) and other variants of CDMA. Further, cdma2000 may cover IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi®), IEEE 802.16 (WiMAX), IEEE 802.20, Flash Orthogonal Frequency-Division Multiplexing (Flash-OFDM), etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2).

The various embodiments provide methods, devices, systems, and non-transitory process-readable storage media for a software-enabled access point mobile computing device to improve the allocation and maintenance of IPv6 prefixes in a prefix delegation mode or scenario. In other words, a software-enabled access point (softAP) mobile computing device configured to utilize a prefix delegation feature for IPv6 network communications may be further configured to locally update prefix assignments for client devices in response to determining that the client devices have disconnected from a LAN. In particular, when a LAN client device (i.e., a client device connected to a LAN connection established by the softAP mobile computing device), having a unique prefix assigned to it from a modem processor of the softAP mobile computing device, disconnects from the router service (i.e., the LAN connection), the softAP mobile computing device may encounter an event indicating the disconnection. The softAP mobile computing device, via its application processor, may report such an event to its modem processor, which may in turn may free-up or release the unique prefix previously assigned to the now disconnected client device so that prefix is available to be assigned to another client device on or accessing the LAN. With dynamic updating of prefix assignments, the softAP mobile computing device may avoid prefix exhaustion in IPv6 backhaul scenarios. Such techniques using hotspots may allow WAN carriers to limit the number of active connected client devices and conduct billing based on the number that are connected. For example, a public, wireless hotspot for an IPv6 backhaul (e.g., a device configured with functionalities for establishing both LAN and IPv6 WAN connections to allow nearby LAN client devices to reach a cellular WAN) may utilize prefix delegation to limit and maintain the freshness of accesses to the WAN by client devices.

In some embodiments, whenever a client device connects or disconnects from the LAN established by the softAP mobile computing device, the softAP mobile computing device (e.g., via a router configuration module executing on an application processor) may receive an event notification from the softAP mobile computing device's operating system (i.e., kernel) or user space modules (i.e., daemons). For example, based on information from a “hostapd” user space daemon for access point and authentication servers related to the LAN (e.g., a wireless LAN (WLAN)), the router configuration software module may receive from a user space module/daemon (e.g., “hostapd_cli”) a hostapd user space daemon event (e.g., an “AP-STA-DISCONNECTED” event) indicating a wireless local area network (WLAN) client device has disconnected from the softAP mobile computing device. As another example, the router configuration software module may receive kernel events (e.g., a “RTM_DELLINK” event) indicating whether a client device has connected or disconnected from a USB connection to the softAP mobile computing device. As another example, the router configuration software module may receive kernel events (e.g., an “RTM_DELNEIGH” event) indicating when an IPv4 or IPv6 address is added, removed, or updated from a neighbor cache.

In response to receiving an event indicating a disconnection of a client device, the softAP mobile computing device (e.g., via its router configuration module executing on the application processor) may perform a look-up for related client device information in an internal cache and get the link-local address of the respective client device. The softAP mobile computing device (e.g., via its router configuration module) may transmit a proprietary message to a modem processor in the softAP mobile computing device. In response, the softAP mobile computing device (e.g., via its modem processor executing a modem IPv6 address configuration module) may delete or otherwise unassign the prefix assigned to that particular client device, thereby freeing up or releasing the prefix for use by other client devices.

In some embodiments, instead of performing operations in response to receiving events indicating a disconnected client device, the softAP mobile computing device may monitor (or run) a timer to periodically check or test whether previously connected client devices have disconnected. For example, after a predefined timer period, the softAP mobile computing device may evaluate whether a certain client device has been disconnected, and if so, may then transmit a message to the modem processor to delete the prefix assigned to that particular client device. Such a timer technique may require more resources/overhead, and thus may be less efficient than the event-based techniques described above.

In some embodiments, the softAP mobile computing device may be configured to utilize prioritization schemes for assigning prefixes to client devices. In particular, the softAP mobile computing device may store lists of device identifiers or other characteristics (e.g., access point associations of devices, credentials, etc.) associated with devices that may be considered “privileged” (i.e., high-priority, high-ranking, etc.). With such stored lists, the softAP mobile computing device may be capable of identifying privileged client devices and ensuring that these privileged client devices are allowed to obtain IPv6 prefixes before and/or instead of non-priority (or lower priority) client devices. For example, when all of the IPv6 addresses are exhausted and a new privileged client requests to connect to the softAP mobile computing device, an IPv6 prefix assigned to a non-privileged client device may be unassigned and then re-assigned to the privileged client device.

In cases in which all prefixes are assigned to privileged client devices, the softAP mobile computing device may maintain a waiting list of privileged client devices that indicates an order that these privileged devices can receive subsequently unassigned prefixes. For example, the list may indicate the next priority client device to receive an IPv6 prefix that is freed in response to another priority client device disconnecting from the LAN of the softAP mobile computing device. Such a priority waiting list may be sorted in various manners, such as by first-in, first-out, importance, or other rankings or characteristics between privileged client devices. In other words, not only may a softAP mobile computing device use the priority waiting list to provide prefixes to privileged client devices over non-privileged client devices, but certain privileged client devices may be allowed to receive prefixes before other privileged client devices based on a relative priority.

In some embodiments, the softAP mobile computing device may determine whether client devices are privileged based on their media access control (MAC) address (i.e., using a MAC address-based prioritization scheme). As a client device's MAC address may be unique with respect to other client devices, the softAP mobile computing device may be configured to use a list of MAC addresses of privileged client devices that may receive priority when IPv6 prefix delegation is supported. In other words, the client devices associated with the MAC addresses listed in the priority list of MAC addresses stored by the softAP mobile computing device may receive IPv6 prefixes before and/or instead of client devices with MAC addresses not on such a MAC address priority list. For example, an administrator or other user of the softAP mobile computing device may input particular MAC addresses of known, high-priority devices that should receive priority over other client devices.

In other embodiments, the softAP mobile computing device may determine whether client devices are privileged based on service set identifiers (SSIDs) (i.e., using a SSID-based prioritization scheme). In other words, when the softAP mobile computing device is configured to support more than one SSID (e.g., one SSID for a primary access point and another SSID for a secondary or guest access point), client devices associated with (or otherwise configured with credentials enabling connections to) a priority SSID may be considered privileged and thus may be assigned IPv6 prefixes over client devices associated with a non-priority SSID (e.g., guest access point). For example, as the softAP mobile computing device may support a primary Wi-Fi® SSID and a guest Wi-Fi® SSID, wherein the client devices connected to the primary Wi-Fi® SSID are considered privileged or priority (e.g., entitled to better bandwidth/connectivity, etc.). In other words, guest client devices associated with the non-priority SSID may only be allowed to obtain an IPv6 prefix when the all prefixes are not already used by privileged client devices connected to the priority SSID.

Conventional techniques may exist in which router devices may transmit messages to a network device (e.g., a network operator server, etc.) to indicate changes to prefix usage in order to provide address relief on the network side. The embodiment techniques differ from conventional techniques in that the embodiment techniques enable a softAP mobile computing device to mange IPv6 prefixes in a prefix delegation scenario without communicating connection or prefix changes to any network device. For example, when a client device disconnects from a LAN as indicated by internal signaling (e.g., kernel events, etc.), the softAP mobile computing device implementing the embodiment techniques may itself identify the disconnected client device based on information in the internal signaling, match the identity to information stored within a cache (e.g., retrieve a local link address), and free a prefix associated with that identity using a modem processor. In other words, the embodiment techniques provide “router-side” IPv6 prefix assignments and management without external messaging to WAN entities.

The various embodiments may be beneficial in avoiding prefix exhaustion in softAP mobile computing devices configured to utilize prefix delegation features in IPv6 scenarios. As conventional IPv6 address management schemes may only enable a modem processor of the softAP mobile computing device to flush IPv6 prefixes when an IPv6 call/backhaul has been terminated (e.g., the softAP mobile computing device has disconnected from the WAN), the various embodiments may enable prefix flushes to occur “on the fly” and without the softAP mobile computing device losing the WAN connection. In this way, client devices may continually connect and disconnect from the softAP mobile computing device without causing prefix exhaustion. Accordingly, the various embodiments improve the functioning of softAP mobile computing devices (e.g., mobile routers) by enabling efficient allocation and de-allocation of resources associated with routing, thus improving connectivity of client devices and throughput to a WAN via the softAP mobile computing devices.

Further, such embodiment techniques using hotspots may be beneficial in allowing WAN carriers to limit the number of active connected client devices and conduct billing based on the number that are connected. For example, a public, wireless hotspot for an IPv6 backhaul (e.g., a device configured with functionalities for establishing both LAN and IPv6 WAN connections to allow nearby LAN client devices to reach a cellular WAN) may utilize prefix delegation to limit and maintain the freshness of accesses to the WAN by client devices.

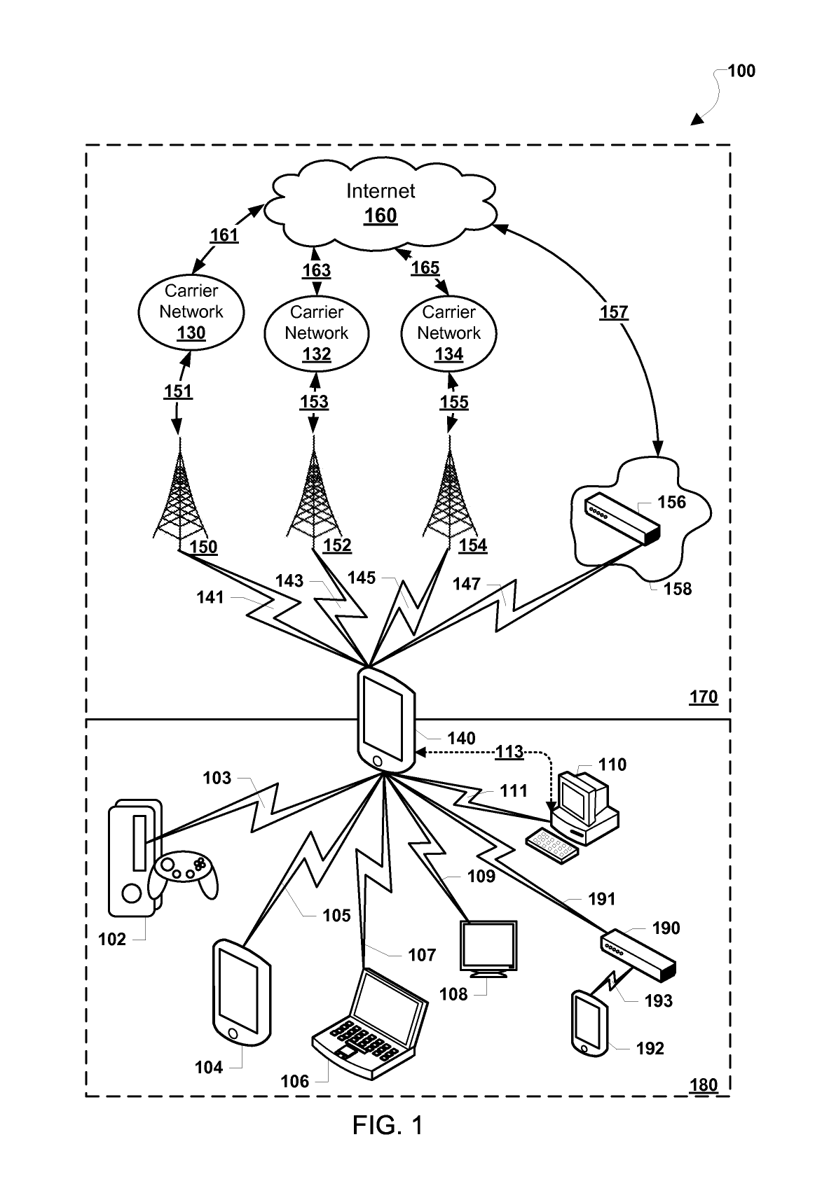

FIG. 1 illustrates a communication system 100 including a software access point (softAP) mobile computing device 140 in wireless communication with various devices. The softAP mobile computing device 140 may be any mobile computing device capable of executing applications, routines, logic, instructions, circuitry, units, modules, and/or other components for enabling software-enabled access point (or mobile router) functionalities. For example, the softAP mobile computing device 140 may include Wi-Fi® transceivers, cellular network chip(s)/modem(s), subscriber identity modules (SIMs or SIM cards), antenna, processor(s), memory(s), and other components that may enable the softAP mobile computing device 140 to establish a local area network (LAN) 180 (e.g., a Wi-Fi® LAN) as well as communicate with various devices in a wide area network (WAN) 170. In particular, the softAP mobile computing device 140 may include components for communicating via wireless wide area network (WWAN) connections 141, 143, 145 with base stations 150, 152, 154 associated with various carrier networks 130, 132, 134 (e.g., cellular networks).

Each of the base stations 150, 152, 154 may be connected to their respective carrier networks 130, 132, 134 via connections 151, 153, 155. The carrier networks 130, 132, 134 may in turn have connections 161, 163, 165, respectively, to the Internet 160. Such base stations 150, 152, 154 and their respective carrier networks 130, 132, 134 may be affiliated with different telecommunication standards and/or protocols, such as Global System for Mobile Communications (GSM), 4^{th} Generation (4G), 3^{rd} Generation (3G), Universal Mobile Telecommunications System (UMTS), etc. For example, the first base station 150 and carrier network 130 may be associated with an long-term evolution (LTE) network, the second base station 152 and carrier network 132 may be associated with a wideband code division multiple access (WCDMA) network, and the third base station 154 and carrier network 134 may be associated with a code division multiple access (CDMA) network. In some embodiments, any combination of the base stations 150, 152, 154 and carrier networks 130, 132, 134 may utilize the same telecommunication standards (e.g., LTE, etc.).

In some embodiments, the softAP mobile computing device 140 may be configured to connect to another access point via wireless communications. For example, the softAP mobile computing device 140 may connect via a wireless connection 147 to a hardware router 156 (or hardware Wi-Fi® access point) associated with a local area network 158 having a connection 157 to the Internet 160. For example, the softAP mobile computing device 140 may utilize a Wi-Fi® transceiver to exchange data with the hardware router 156. In other words, the softAP mobile computing device 140 may utilize a Wi-Fi® backhaul via the hardware router 156 and/or other backhauls via the various base stations 150, 152, 154.

Executing software for enabling a connectable software access point (or software-enabled access point router), the softAP mobile computing device 140 may be capable of providing a local area network (LAN) 180 that may provide a plurality of client devices access to the various resources and/or devices via the WAN 170. In particular, the softAP mobile computing device 140 may serve as a LAN router (or hub) that provides a WAN connection for various client devices having wireless connection capabilities (e.g., Wi-Fi®, etc.), such as a game console 102 (e.g., Xbox 360®, Xbox One®, etc.), a smartphone 104 (or tablet device), a laptop computer 106, a television device 108 (e.g., a smart TV), a desktop computer 110 (or personal computer), and a local router device 190.

Each of the client devices 102, 104, 106, 108, 110, 190 may be configured to connect to the softAP mobile computing device 140 via wired or wireless connections 103, 105, 107, 109, 111, 191. For example, the game console 102 may connect to the softAP mobile computing device 140 via a first connection 103, the smartphone 104 may connect to the softAP mobile computing device 140 via a second connection 105, the laptop computer 106 may connect to the softAP mobile computing device 140 via a third connection 107, the television device 108 may connect to the softAP mobile computing device 140 via a fourth connection 109, the desktop computer 110 may connect to the softAP mobile computing device 140 via a fifth connection 111, and the local router device 190 may connect to the softAP mobile computing device 140 via a sixth connection 191. As another example, the desktop computer 110 may connect to the softAP mobile computing device 140 via a universal serial bus (USB) connection 113 instead of or in addition to connecting to the softAP mobile computing device 140 via a Wi-Fi® connection.

In various embodiments, the connections 103, 105, 107, 109, 111, 191 may be wired (e.g., USB connections, etc.) or wireless (e.g., Wi-Fi® connections, etc.). In some embodiments, the connections 103, 105, 107, 109, 111, 191 may utilize various short-range or long-range wireless communication technologies, protocols, and/or standards, such as Bluetooth®, ZigBee®, Wi-Fi® Direct, RF, etc.

In IPv6 prefix delegation operations, the softAP mobile computing device 140 may utilize a short prefix provided by a network resource (e.g., a 56-bit prefix, etc.) and the various client devices 102, 104, 106, 108, 110, 190 may utilize unique prefixes generated by the softAP mobile computing device 140 based on the short prefix. For example, each of the client devices 102, 104, 106, 108, 110, 190 may be assigned a 64-bit prefix in response to connected to the LAN 180 established by the softAP mobile computing device 140.

In some embodiments, the softAP mobile computing device 140 may indirectly provide a WAN connection to other devices. In particular, the local router device 190 connected to the WAN 170 via the LAN 180 established by the softAP mobile computing device 140 may in turn provide the WAN connection to another mobile computing device 192 via a Wi-Fi®, Bluetooth®, or other wired or wireless connection. In such a case, the other mobile computing device 192 may utilize any prefix designated to the local router device 190 by the softAP mobile computing device 140.

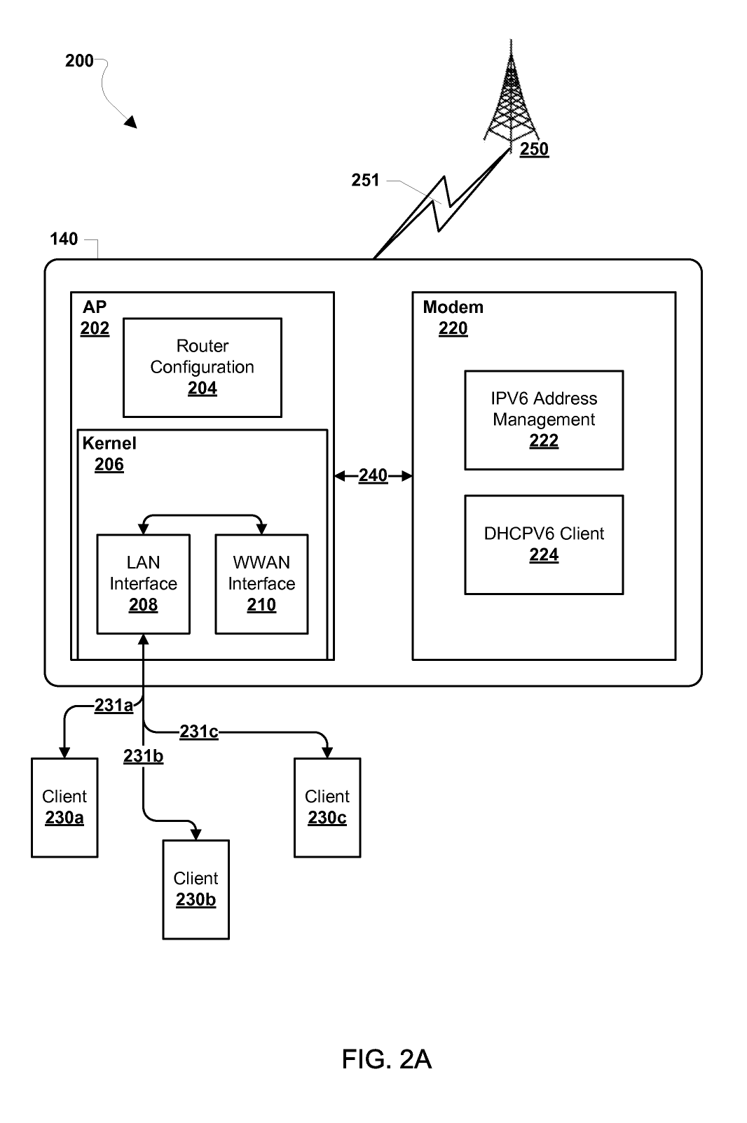

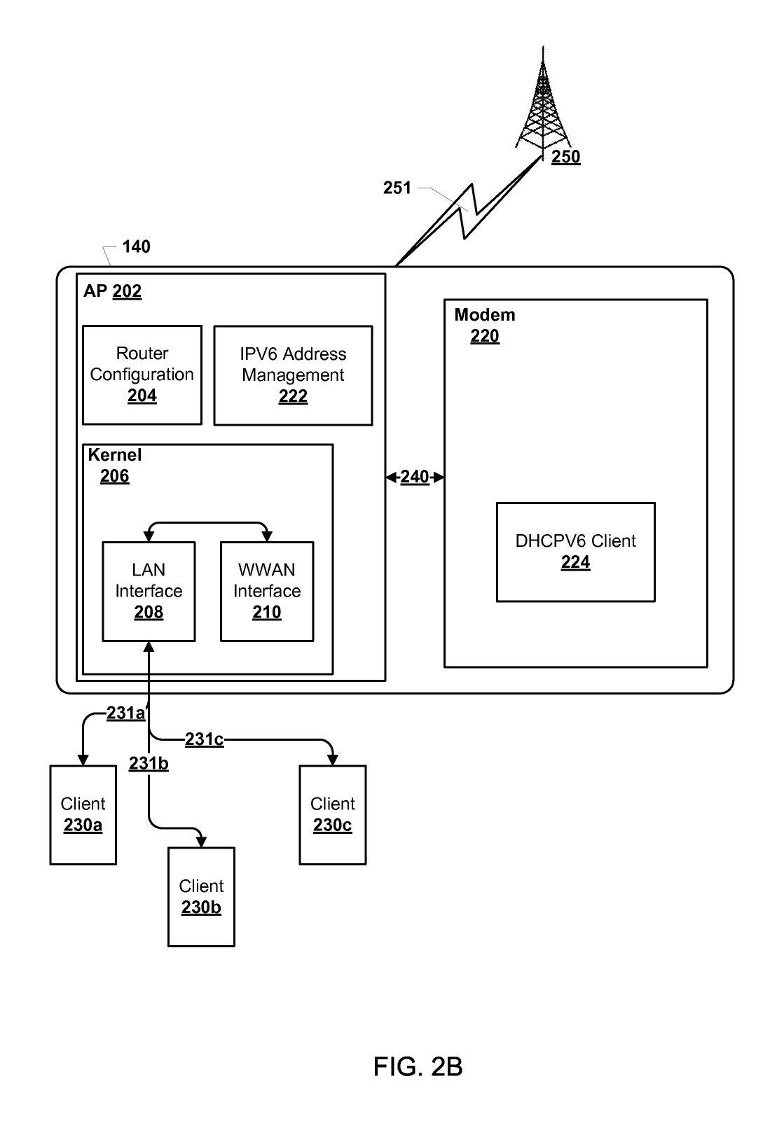

FIG. 2A illustrates modules within a softAP mobile computing device 140 configured to operate as a mobile router suitable for use in various embodiments. As described above, the softAP mobile computing device 140 may include various components and functionalities for conducting communications with resources in a wide area network (WAN). For example, the softAP mobile computing device 140 may include antennas/transceivers configured to exchange communications with a base station 250 of a cellular network via a wireless wide area network (WWAN) connection 251. The softAP mobile computing device 140 may include various components and functionalities for establishing a local area network (LAN) and conducting communications with resources connected to the LAN. For example, the softAP mobile computing device may include a Wi-Fi® transceiver configured to exchange signals with nearby client devices 230a-230c via wireless connections 231a-231c (e.g., Wi-Fi® communications, etc.).

The softAP mobile computing device 140 may include an application processor 202 configured to execute various software applications, modules, routines, instructions, and other operations. The application processor 202 may be configured to execute a router configuration module 204 (or mobile AP router configuration module or daemon) and a kernel module 206 (e.g., an operating system), such as Linux, Android, iOS, and/or Windows. In some embodiments, the router configuration module 204 may be configured to send router solicitation messages on behalf of connected client devices to a IPv6 address configuration module 222 supported by the modem processor 220. The kernel module 206 may be configured to enable various functionalities of the softAP mobile computing device, such as operations for controlling a LAN interface module 208 for processing communications associated with a local area network (e.g., Wi-Fi® communications with client devices 230a-230c, etc.), as well as a wireless wide area network (WWAN) interface module 210.

The softAP mobile computing device 140 may also include a modem including a modem processor 220 configured to execute and otherwise support various software modules for handling communications. In particular, the modem processor 220 may be configured to execute an IPv6 address management module 222 and a dynamic host configuration protocol (DHCP) v6 client device module 224 (or DHCPv6 client device module) for handling IP addresses. The DHCPv6 client device module 224 may be configured to obtain a short prefix (or a delegated prefix), such as a 56-bit (or /56) unique prefix, from a network resource in response to requests (or triggers) from the IPv6 address management module 222. The IPv6 address management module 222 may be configured to assign unique prefixes (e.g., 64-bit prefixes) to connected client devices based on the short prefix received from the network resource. When the DHCPv6 client device module 224 obtains a short prefix from the network (e.g., a /56 prefix), the modem processor 220 may be capable of generating and assigning unique prefixes (e.g., 64-bit prefixes) for various connected client devices, such as by generating linearly increasing 64-bit prefixes based on the short prefix. The modem processor 220 and the application processor 202 may be connected via a bus 240 for exchanging data and various signaling between the processing units.

FIG. 2B illustrates modules within a softAP mobile computing device 140 configured to operate as a mobile router according to another embodiment. The softAP mobile computing device 140 of the embodiment illustrated in FIG. 2B may operate in a manner similar to the softAP mobile computing device 140 described above with reference to FIG. 2A, except that in the softAP mobile computing device 140 of the embodiment illustrated in FIG. 2B, the IPv6 address management module 222 may be executed by the application processor 202.

The following is an illustration of an interaction between the various components of the softAP mobile computing device 140 for obtaining managing unique prefixes for a client device 230a according to some embodiments. The modem processor 220 may be configured to directly setup a WAN connection (or PDN connection) with a wide area network (e.g., an LTE cellular network). The DHCPv6 client device module 224 may be configured to obtain a short prefix (e.g., a /56 prefix, etc.) from WAN resources via the WAN connection. Via the LAN interface module 208 and kernel module 206, the application processor 202 may receive a solicitation message from a client device 230a, indicating that the client device 230a is requesting a connection to an established LAN, and thus also utilize the WAN connection established by the softAP mobile computing device 140. The LAN interface module 208 may transfer the solicitation message indicating that the identifier of the client device 230a through the WWAN interface module 210 to the modem processor 220 to be handled by the IPv6 address management module 222. In response, the IPv6 address management module 222 may assign a unique IPv6 prefix (e.g., 64-bit) to the client device 230a that is based on the obtained short prefix (e.g., 56-bit). The unique IPv6 prefix may be transmitted to the router configuration module 204 for storage in a cache in association with the identifier of the client device 230a. In some embodiments, when the IPv6 address management module 222 is not executed by the modem processor 220 but instead the application processor 202, the solicitation message indicating that the identifier of the client device 230a may not need to be transmitted through the WWAN interface module 210 to be handled by the IPv6 address management module 222.

After an arbitrary period of time, the application processor 202 may encounter an event (e.g., an event generated by the kernel module 206) that indicates that the client device 230a has disconnected from the LAN established by the softAP mobile computing device 140. In response, the router configuration module 204 may perform a lookup on the cache to identify the IPv6 address associated with the identifier of the client device 230a, and may transmit a message via the bus 240 to the modem processor 220 indicating the prefix of the client device 230a. In response, the modem IPv6 address management module 222 may delete the prefix assigned to the client device 230a, enabling another client device to be subsequently assigned the same prefix. In some embodiments, when the IPv6 address management module 222 is not executed by the modem processor 220 but instead the application processor 202, the router configuration module 204 may not transmit a message via the bus 240 to the modem processor 220 indicating the prefix of the client device 230a. Instead, the router configuration module 204 may send another signal within the application processor 202 to communicate with the IPv6 address management module 222.

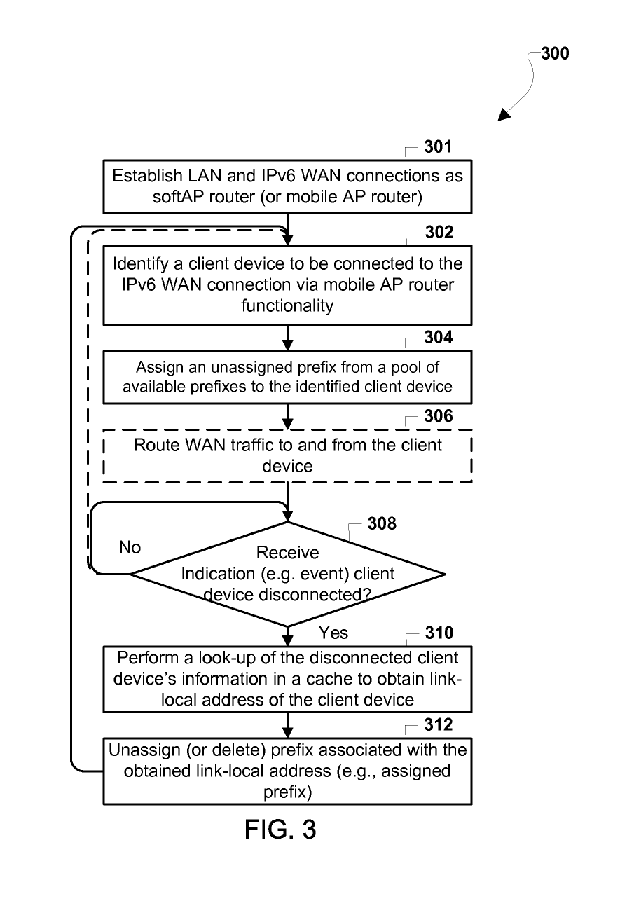

FIG. 3 illustrates an embodiment method 300 for a mobile computing device configured to operate as a mobile router (i.e., a softAP mobile computing device) to unassign IPv6 prefixes in response to the disconnection of client devices from a local area network (LAN) connection. As indicated above, the assignment and release of IPv6 prefixes to client devices by the softAP mobile computing device do not require operations to be performed by a network entity (e.g., a network operator device), as the prefixes are locally managed by the softAP mobile computing device, such as via the router configuration module 204 and IPv6 address management module 222 described above. Further, operations of method 300 may be performed by various processors of the softAP mobile computing device, such as an application processor and/or a modem processor as described above.

In block 301, the softAP mobile computing device may establish a local area network connection (LAN) and an IPv6 wide area network (WAN) connection. In other words, the softAP mobile computing device may establish the IPv6 WAN connection and begin operating as a mobile router. For example, the established IPv6 WAN connection may be a connection between the softAP mobile computing device and a base station associated with a cellular network and/or a Wi-Fi® router device connected to the Internet. As another example, the softAP mobile computing device may establish a Wi-Fi® LAN and may broadcast a service set identifier (SSID) that may be used by client devices to connect to the LAN.

The operations of block 301 may include the softAP mobile computing device obtaining a short prefix (e.g., a /56 prefix) from a network resource, with which the softAP mobile computing device may generate a finite number of unique prefixes (e.g., /64 prefixes) to assign to various client devices. For example, for IPv6 WAN connections requiring 64-bit prefixes, in response to receiving a 56-bit short prefix (or subscriber prefix), the softAP mobile computing device may be capable of generating 64-bit client device unique prefixes using the same 56-bit short prefix and adjustable 8 bits (i.e., 64 bits of maximum prefix allocation−56 bits of short prefix=8 bits that may change for making unique numbers to be combined with the 56 bits of the short prefix). Operations of block 301 for establishing the IPv6 WAN connection may be performed by the softAP mobile computing device via a modem processor as described above.

In block 302, the softAP mobile computing device may identify a client device to be connected to the IPv6 WAN connection via its mobile AP router functionality. In other words, in response to received messages or events (e.g., kernel events), the softAP mobile computing device may determine that a client device has connected to the LAN established with the operations in block 301, and thus the client device and should be assigned a unique prefix for WAN communications. The softAP mobile computing device may maintain information about all client devices connected to the LAN. For example, the softAP mobile computing device may store data that is updated based on events generated by a Wi-Fi® driver and/or kernel that indicate current client devices, such as events that indicate the IP address and/or media access control (MAC) address of a client device that has connected to the softAP mobile computing device's LAN.

In some embodiments, the softAP mobile computing device may identify that a client device (e.g., a WLAN client device) has wirelessly connected to the LAN based on receiving an “AP-STA-CONNECTED” event from a hostapd user space daemon via a hostapd_cli user space daemon. The “AP-STA-CONNECTED” event may be generated by a hostapd user space daemon whenever a client device connects and may include information about the MAC address of the client device. Such a hostapd user space daemon may be associated with operations for access point and authentication servers, and may further be responsible for broadcasting SSIDs to reach WLAN client devices and obtain data connectivity.

In some embodiments, the softAP mobile computing device may identify that a client device, such as a USB client device configured to utilize a Remote Network Driver Interface Specification (RNDIS) protocol or an Ethernet Control Module (ECM) protocol, has connected to the LAN via a USB connection. For example, such an identification may be based on the softAP mobile computing device receiving an “RTM_NEWLINK” kernel event from the kernel or operating system of the softAP mobile computing device. Such kernel events may include the IP address of connected client devices, and may be generated by the kernel whenever an RNDIS or ECM interface is created or otherwise detected by the softAP mobile computing device.

In some embodiments, the softAP mobile computing device may identify that a client device, such as a wireless LAN (WLAN)/USB client device, has connected to the LAN via a USB or wireless connection. For example, such an identification may be based on the softAP mobile computing device receiving an “RTM_NEWNEIGH” kernel event from the kernel or operating system of the softAP mobile computing device. Such kernel events may be generated by the kernel when a neighbor cache is updated with an IPv4/IPv6 address.

In block 304, the softAP mobile computing device may assign an unassigned prefix (e.g., a 64-bit prefix) of a pool of available prefixes to the identified client device. For example, via a modem processor, the softAP mobile computing device may generate a unique 64-bit prefix for the client device based on a short prefix (e.g., a 56-bit short prefix, etc.) previously obtained from network resources. The pool of available prefixes may be all prefixes the softAP mobile computing device is permitted to assign based on the short prefix (e.g., /56) assigned to the softAP mobile computing device by the network resource. Further, the pool of available prefixes may include assigned prefixes that are already assigned to client devices connected to the established LAN and unassigned prefixes associated with no client device.

As described above, when configured to utilize a prefix delegation feature of IPv6 communications, the softAP mobile computing device may utilize or assign a finite number of prefixes based on the short prefix obtained from network resources (i.e., a short 56-bit prefix assigned to the softAP mobile computing device as a router). For example, when the short prefix obtained from network resources is 56 bits but the IPv6 prefix size is 64 bits, the softAP mobile computing device may use the difference of 8 bits to generate unique prefixes for client devices. Accordingly, the softAP mobile computing device may generate or identify a currently unused 64-bit prefix that is based on the short prefix (e.g., 56-bit). In some embodiments, the softAP mobile computing device may utilize a table or other data structure to manage current assignments for unique prefixes, such as a data table including all assigned prefixes. As another example, such a data table may include entries for all possible prefixes capable of being assigned based on the short prefix, with each entry associated with a bit or flag indicating whether it is currently assigned to a client device. In some embodiments, the operations in block 304 may be performed by a modem processor in the softAP mobile computing device.

In some embodiments, the softAP mobile computing device may assign the prefix in response to a router solicitation message being received at the softAP mobile computing device and communicated from the application processor to the modem processor of the softAP mobile computing device. In some embodiments, a client device may transmit the router solicitation message to the softAP mobile computing device when connecting to the LAN. A router configuration module of the softAP mobile computing device may transmit the router solicitation message on behalf of the client device in response to the client device connecting to the LAN.

In some embodiments, in response to assigning the prefix to the client device, the softAP mobile computing device may store the assigned prefix in association with identifying information (e.g., MAC address, IP address, etc.) of the client device, such as within an internal cache accessible by the application processor (and the router configuration module) of the softAP mobile computing device. Further, the assigned prefix may be communicated to the corresponding client device, such as in an acknowledgement message or signal sent to the client device from the softAP mobile computing device via a Wi-Fi® connection of the LAN.

In optional block 306, the softAP mobile computing device may route WAN traffic to and from the client device using the assigned prefix. For example, the softAP mobile computing device may receive data packets from the client device via a WLAN connection and in turn may transmit those data packets to a base station of a cellular network for delivery to a remote source over the Internet. The operations in optional block 306 may be performed for an arbitrary time.

Client devices connected to the LAN established by the softAP mobile computing device may disconnect at any time (e.g., device shut-down/failure, deactivate Wi-Fi® transceiver, etc.). Subsequent re-connections of disconnected client devices to the LAN may cause the softAP mobile computing device to assign new prefixes. Unlike in conventional methods, the softAP mobile computing device may perform book-keeping operations to ensure unused prefixes are returned to the pool of possible (or available) prefixes that may be assigned to subsequent client devices.

In determination block 308, the softAP mobile computing device may determine whether it has received any indication (e.g., a kernel event) that a client device with an assigned prefix has disconnected from the LAN established by the softAP mobile computing device. For example, the softAP mobile computing device may monitor for particular events, signals, and/or messages indicating a previously-connected client device has disconnected from the LAN. In some embodiments, the operations of determination block 308 may be performed by the application processor of the softAP mobile computing device.

In some embodiments, the softAP mobile computing device may identify that a client device (e.g., a WLAN client device) has wirelessly disconnected from the LAN based on receiving a notification or event from a hostapd user space daemon via a hostapd_cli user space daemon. For example, the softAP mobile computing device may receive an “AP-STA-DISCONNECTED” event generated by a hostapd user space daemon whenever a client device disconnects and that includes information about the MAC address of the client device. In some embodiments, the softAP mobile computing device may identify that a client device, such as a USB client device configured to utilize a Remote Network Driver interface Specification (RNDIS) protocol or an Ethernet Control Module (ECM) protocol, has disconnected from the LAN via a USB connection based on receiving a related event. For example, such an identification may be based on the softAP mobile computing device receiving an “RTM_DELLINK” kernel event from the kernel or operating system of the softAP mobile computing device. Such kernel events may include the IP address of client devices, and may be generated by the kernel whenever an RNDIS or ECM interface is deleted by the softAP mobile computing device. In some embodiments, the softAP mobile computing device may identify that a client device, such as a wireless LAN (WLAN)/USB client device, has disconnected from the LAN via a USB or wireless connection. For example, such an identification may be based on the softAP mobile computing device receiving an “RTM_DELNEIGH” kernel event from the kernel or operating system of the softAP mobile computing device. Such kernel events may be generated by the kernel when a neighbor cache is deleted from the neighbor cache.

In response to determining that a client device has not disconnected from the LAN (i.e., determination block 308=“No”), the softAP mobile computing device may continue to monitor for disconnections by performing the operations in determination block 308. In response to determining that a client device has disconnected from the LAN (i.e., determination block 308=“Yes”), the softAP mobile computing device may perform a look-up of the disconnected client device's information in a cache to obtain a link-local address of the client device in block 310. For example, a router configuration module via the application processor of the softAP mobile computing device may utilize a MAC address or IP address indicated in a received kernel event to perform the look-up in an internal cache (e.g., a data table accessible to the application processor of the softAP mobile computing device) to obtain the identifying information of the disconnected client device that the modem processor may utilize to unassign a prefix. In other words, based on the look-up, the softAP mobile computing device may retrieve the unique prefix previously assigned to the now-disconnected client device.

In block 312, the softAP mobile computing device may unassign (or delete) the prefix associated with the obtained link-local address. In other words, the softAP mobile computing device may de-associate the assigned prefix with the client device that has been identified as now disconnected from the LAN established by the softAP mobile computing device. In some embodiments, the un-assignment (or deletion) may be performed by the modem processor or the application processor of the softAP mobile computing device via an IPv6 address management module as described above. For example, the IPv6 address management module executing on the modem processor or the application processor of the softAP mobile computing device may receive a message (e.g., a proprietary message including the prefix) from the router configuration module executing on the application processor of the softAP mobile computing device, and in response may delete a data table entry or other stored data associating the disconnected client device with the prefix. In this manner, the softAP mobile computing device may free prefixes that are not in use based on events indicating client devices have disconnected from the LAN of the softAP mobile computing device.

In some embodiments, the look-up may be performed via an application processor of the softAP mobile computing device and the unassigning may be performed via one of the application processor and a modem processor of the softAP mobile computing device. For example, the application processor may transmit a message to the modem processor indicating that the prefix is to be unassigned in response to performing the look-up described above, and the modem processor may unassign the prefix in response to receiving the message from the application processor.

The various operations of the method 300 may be performed concurrently with respect to various client devices (e.g., a plurality of client devices). For example, while routing WAN traffic related to a first client device assigned to a first IPv6 prefix, the softAP mobile computing device may concurrently identify a second client device to be connected to the WAN and accordingly assign a second IPv6 prefix. As another example, while routing WAN traffic for a first client device, the softAP mobile computing device may concurrently receive an indication of a disconnection of a second client device and thus unassign the prefix for the second client device. In other words, the softAP mobile computing device may not be forced to wait to receive a disconnection indication (e.g., kernel event) before identifying a new client device connection, and vice versa.

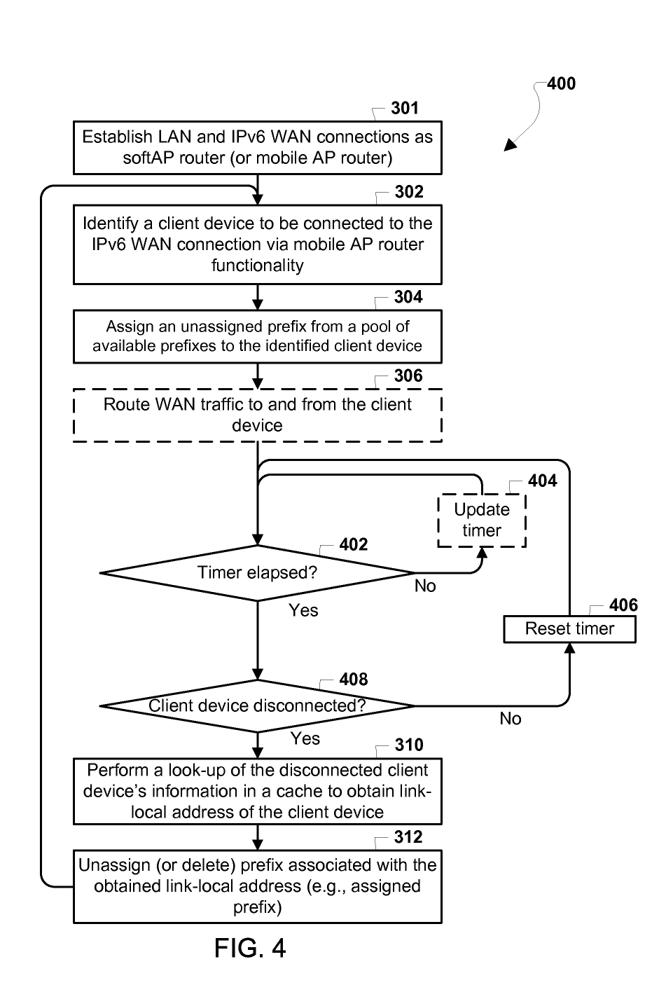

FIG. 4 illustrates another embodiment method 400 for a mobile computing device configured to operate as a mobile router (i.e., a softAP mobile computing device) to unassign prefixes in response to the disconnection of client devices from a local area network connection. The method 400 is similar to the method 300 described above, except that the operations in method 400 may include operations for evaluating a timer to determine whether to check if client devices are disconnected from the LAN connection to the softAP mobile computing device. In other words, instead of passively receiving event messages indicating client devices have disconnected from the LAN connection, the softAP mobile computing device may proactively and periodically check previously connected client devices to identify those that are no longer connected. Such a technique may require additional resources of the softAP mobile computing device.

The operations in blocks 301-306 are similar to as described above with reference to FIG. 3. In determination block 402, the softAP mobile computing device may determine whether a timer has elapsed. For example, the softAP mobile computing device may evaluate a current timer value or variable value associated with the timer, or alternatively evaluate a value of a system clock, to determine whether a predefined period of time has elapsed. In some embodiments, the timer may be an incrementing or a decrementing counter. In response to determining that the timer has not elapsed (i.e., determination block 402=“No”), the softAP mobile computing device may update the timer in optional block 404, such as by decrementing the timer's value by a predefined amount when the timer is configured to count down or by incrementing the timer's value when the timer is configured to count up. The softAP mobile computing device may then continue performing the operations in determination block 402.

In response to determining that the timer has elapsed (i.e., determination block 402=“Yes”), the softAP mobile computing device may determine (or test) whether a client device has disconnected from the LAN established by the softAP mobile computing device in determination block 408. For example, the softAP mobile computing device may transmit a ping or other message to the client device and listen for a response. Alternatively, the softAP mobile computing device may evaluate events generated over a period of time to determine whether any indicate a disconnection (e.g., a buffered set of kernel events). In some embodiments, the softAP mobile computing device may iteratively check the connection status of each in a plurality of client devices that are known to have valid connections at the last evaluation operations (e.g., all devices confirmed to be connected at the last time the timer elapsed).

In response to determining that the client device has not disconnected (i.e., determination block 408=“No”), the softAP mobile computing device may reset the timer in block 406, such as by resetting the value of the timer to a predefined default value (e.g., 0 when the timer is configured to count up or to a maximum default value when the timer is configured to count-down, etc.). In some embodiments, the refresh of the timer may happen from the device side itself and the softAP mobile computing device may utilize (e.g., send) data with the new lifetimes (or timer values) for the timer. The softAP mobile computing device may continue with the operations in determination block 402. In response to determining that the client device has disconnected (i.e., determination block 408=“Yes”), the softAP mobile computing device may continue with the look-up operations in block 310 and the unassigning operations in block 312 as described above. For example, the softAP mobile computing device may look-up a prefix for a MAC address when an associated client device does not respond to a ping message transmitted by the softAP mobile computing device.

In various embodiments, the operations of the method 400 (e.g., blocks 402-408, etc.) may be performed by the application processor and/or the modem processor of the softAP mobile computing device.

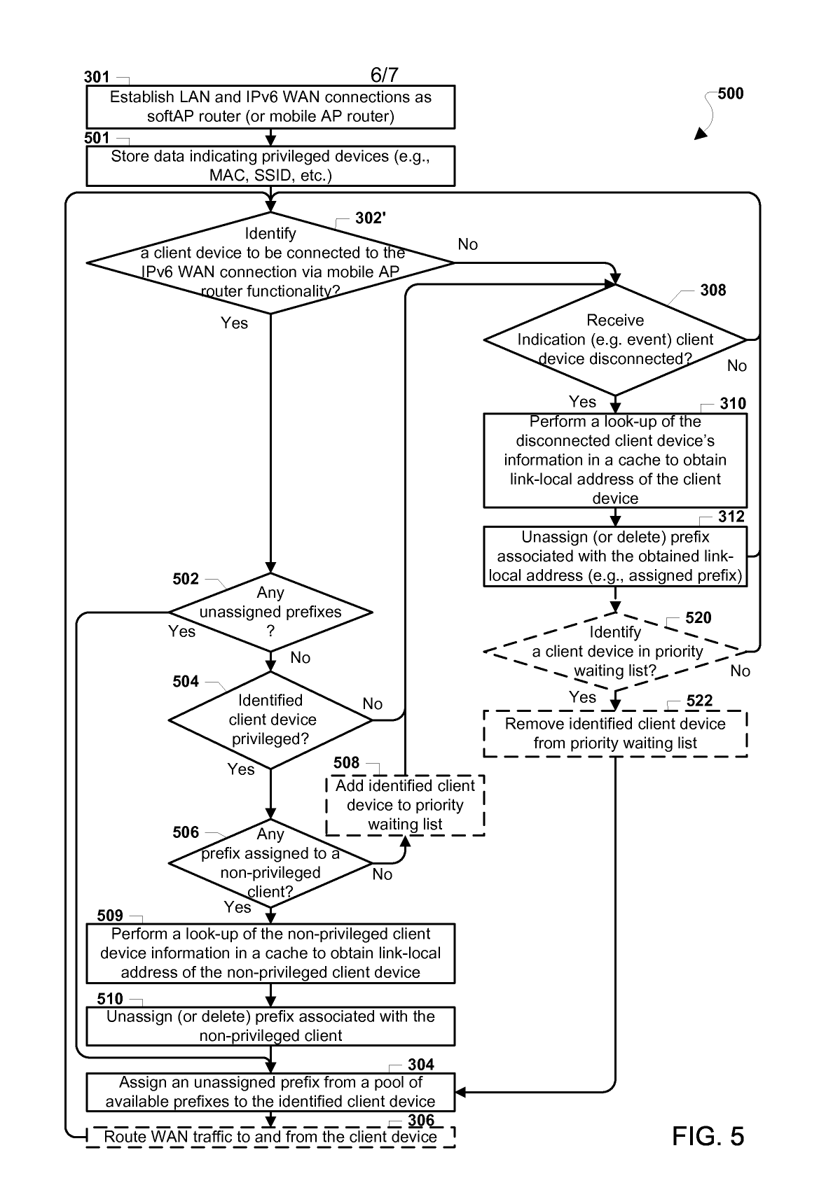

FIG. 5 illustrates an embodiment method 500 for a mobile computing device configured to operate as a software-enabled access point (or mobile router) to unassign prefixes based on priority information and in response to the disconnection of client devices from a local area network connection. The method 500 is similar to the method 300 described above, except that the method 500 may include operations for implementing prioritization schemes, such as providing prefixes to privileged client devices based on SSID or MAC address as stored in a predefined list. For example, the method 500 may be performed by the softAP mobile computing device to drop non-privileged client devices from WAN and LAN connections, freeing up prefixes for re-allocation to privileged client devices. In some embodiments, the privileged client devices may themselves be prioritized between each other, such as based on predefined priority, rank, or other characteristics. Such relative prioritization may be used to sort privileged client devices waiting to be assigned prefixes (i.e., in a priority waiting list). In various embodiments, operations of the method 500 may be performed by various processors of the softAP mobile computing device, such as an application processor and/or a modem processor as described above.

The operations in blocks 301-312 are similar to the like-numbered operations described above with reference to FIG. 3. In block 501, the softAP mobile computing device may store data indicating privileged devices, such as by storing lists of identifiers or characteristics that are associated with priority or otherwise privileged client devices, services, etc. In particular, the stored data may include a list of media access control (MAC) addresses of privileged client devices and/or a list of one or more service set identifiers (SSIDs) used by privileged client devices. For example, the softAP mobile computing device may store an administrator-generated list of all MAC addresses of smartphones of privileged users that should always be given priority in allocating IPv6 prefixes.

In determination block 302′, the softAP mobile computing device may determine whether it has identified a client device to be connected to the IPv6 WAN connection via mobile AP router functionality (e.g., determine whether a client device has requested to obtain an IPv6 prefix). The operations in determination block 302′ may be similar to those described above with reference to block 302 in FIG. 3, except that instead of merely identifying a client device, the operations in determination block 302′ may determine whether a client device is identified that is requesting to be connected to the IPv6 WAN connection, such as may be performed with a periodic polling of a request buffer, etc. In other words, operations for assigning prefixes may only occur in response to determining that a client device is identified to be connected to a WAN connection.

In response to determining that a client device to be connected to the IPv6 WAN connection is identified (i.e., determination block 302′=“Yes”), the softAP mobile computing device may determine whether there are any unassigned prefixes that may be assigned to the identified client device in determination block 502. For example, the softAP mobile computing device may evaluate various stored data (e.g., data tables) that indicate whether each of the possible IPv6 prefixes allocated to the softAP mobile computing device have already been assigned to client devices. In response to determining that there are no unassigned prefixes that may be assigned to the identified client device (i.e., determination block 502=“No”), the softAP mobile computing device may determine whether the identified client device is privileged in determination block 504. Such a determination may be based on an evaluation of the data indicating privileged devices stored with the operations of block 501 described above. For example, the softAP mobile computing device may compare a unique identifier (e.g., MAC address) of the identified client device to a stored list of privileged client device identifiers. As another example, the softAP mobile computing device may compare the SSID associated with the identified client device to a predefined priority SSID to identify whether that identified client device is thus privileged.

In response to determining that the identified client device is not privileged (e.g., determination block 504=“No”), the softAP mobile computing device may continue with the operations in determination block 308 for determining whether an indication is received of a disconnected client device. In this way, the non-privileged client device may eventually be able to be assigned a prefix once there is an available prefix that is not to be assigned to a privileged client device.

In response to determining that the identified client device is privileged (e.g., determination block 504=“Yes”), the softAP mobile computing device may determine whether any prefix that is currently assigned is assigned to a non-privileged client device in determination block 506. In other words, the softAP mobile computing device may evaluate a list of all client devices currently assigned to IPv6 prefixes to determine whether there are any client devices that may be dropped in order to give the higher priority, identified client device access to the WAN connection.

In response to determining that there are no non-privileged client devices that currently are assigned prefixes (i.e., determination block 506=“No”), the softAP mobile computing device may add the identified client device to a priority waiting list in optional block 508. For example, the softAP mobile computing device may store the identifier (e.g., MAC address, etc.) of the identified client device in a list, array, data table, or other data structure that represents all privileged client devices currently waiting to receive an IPv6 prefix. Such a list may maintain the order in which the privileged client devices requested access to the WAN connection so that the first to request may be the first to eventually be assigned a prefix. In some embodiments, the priority waiting list may be sorted based on time of client device request for WAN connection access or other characteristics, such as different ranks, priority levels, or other indicia of importance that differentiates between privileged client devices. The softAP mobile computing device may continue with the operations in determination block 308 for determining whether an indication is received of a disconnected client device.

In response to determining that there are non-privileged client devices that currently are assigned prefixes (i.e., determination block 506=“Yes”), the softAP mobile computing device may perform a look-up of the non-privileged client device information in a cache to obtain a link-local address of the non-privileged client device in block 509. The operations in block 509 may be similar to those described above with reference to block 310. In block 510, the softAP mobile computing device may unassign (or delete) a prefix associated with the non-privileged client, thereby freeing up that prefix for assignment to the privileged, identified client device. For example, the softAP mobile computing device, via its modem, may compare an identifier of a non-privileged client device to a stored list of device identifiers and corresponding assigned prefixes, and may free the assigned prefix that corresponds to a matching device identifier. The operations in block 510 may be similar to those described above with reference to block 312.

In response to determining that there are unassigned prefixes (i.e., determination block 502=“Yes”) or in response to performing the operations of blocks 510 or 522 (as described below), the softAP mobile computing device may perform the assigning operations in block 304, route WAN traffic with the operations in optional block 306, and continue with the operations for identifying new client devices to be assigned prefixes in determination block 302′ as described herein.

In response to determining that no client device to be connected to the IPv6 WAN connection is identified (i.e., determination block 302′=“No”), the softAP mobile computing device may perform the operations of blocks 308-312 as described above. In response to determining that no indication that a client device has disconnected from the LAN has been received (i.e., determination block 308=“No”), the softAP computing device may continue with the operations in determination block 302′. In response to determining that an indication that a client device has disconnected from the LAN has been received (i.e., determination block 308=“Yes”), the softAP computing device may perform the look-up operations of block 310 and unassigning operations of block 312, and may continue with the operations of determination block 302′ as described above.

In some embodiments, in response to performing the unassigning operations in block 312, the softAP mobile computing device may determine whether it identifies a client device in the stored priority waiting list in optional determination block 520. In other words, the softAP mobile computing device may determine whether a privileged client device was previously placed on the priority waiting list in order to receive a recently freed prefix. If so, such a waiting list client device may be assigned the prefix unassigned with the operations in block 312. Accordingly, in response to determining that no client device is in the priority waiting list (i.e., optional determination block 520=“No”), the softAP computing device may continue with the operations in determination block 302′ as described above. In response to determining that a client device is identified in the priority waiting list (i.e., optional determination block 520=“Yes”), the softAP mobile computing device may remove the identified client device from priority list in optional block 522 and assign the freed and now available prefix to the identified client device removed from the priority list in block 304.

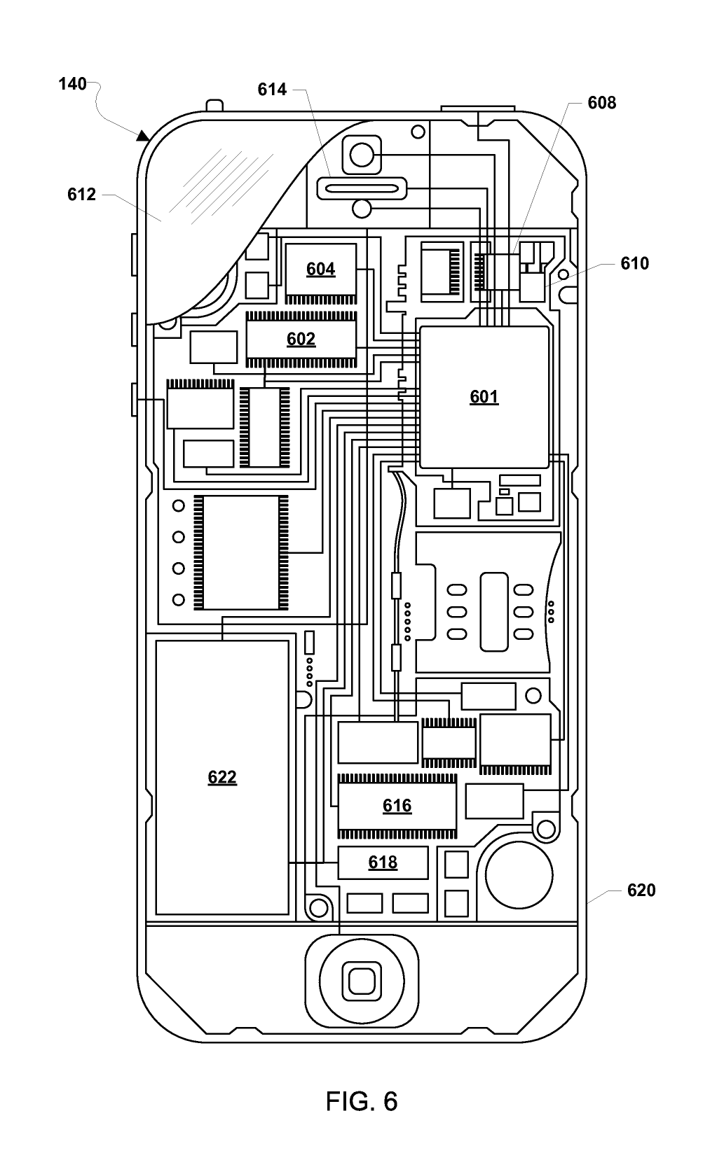

Various embodiments may be implemented in any of a variety of computing devices. For example, FIG. 6 illustrates a mobile computing device 140 suitable for use in various embodiments. In various embodiments, the mobile computing device 140 may include a processor 601 coupled to a touch screen controller 604 and an internal memory 602. The processor 601 may be one or more multicore integrated circuits (ICs) designated for general or specific processing tasks. The internal memory 602 may be volatile or non-volatile memory, and may also be secure and/or encrypted memory, or unsecure and/or unencrypted memory, or any combination thereof. The touch screen controller 604 and the processor 601 may also be coupled to a touch screen panel 612, such as a resistive-sensing touch screen, capacitive-sensing touch screen, infrared sensing touch screen, etc. The mobile computing device 140 may have one or more radio signal transceivers 608 (e.g., Peanut®, Bluetooth®, ZigBee®, Wi-Fi®, RF, cellular, etc.) and antennae 610, for sending and receiving, coupled to each other and/or to the processor 601. The transceivers 608 and antennae 610 may be used with the above-mentioned circuitry to implement the various wireless transmission protocol stacks and interfaces. The mobile computing device 140 may include a cellular network wireless modem chip 616 that enables communication via a cellular network and is coupled to the processor. The mobile computing device 140 may include a peripheral device connection interface 618 coupled to the processor 601. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The mobile computing device 140 may also include speakers 614 for providing audio outputs. The mobile computing device 140 may also include a housing 620, constructed of a plastic, metal, or a combination of materials, for containing all or some of the components discussed herein. The mobile computing device 140 may include a power source 622 coupled to the processor 601, such as a disposable or rechargeable battery. The rechargeable battery may also be coupled to the peripheral device connection port to receive a charging current from a source external to the mobile computing device 140.

Processors of computing devices suitable for use in various embodiments may be any programmable microprocessor, microcomputer or multiple processor chip or chips that can be configured by software instructions (applications) to perform a variety of functions, including the functions of the various embodiments described above. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The steps of a method or algorithm disclosed herein may be embodied in a processor-executable software module or processor-executable instructions (or software instructions) which may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for preventing IPv6 address exhaustion in prefix delegation mode by a software-enabled access point (“softAP”) mobile computing device providing an Internet Protocol version 6 (IPv6) wide area network (WAN) connection to a plurality of client devices, comprising:
assigning, by the softAP mobile computing device, an unassigned prefix of a pool of available prefixes to a client device connected to a local area network (LAN) established by the softAP mobile computing device;
determining, by the softAP mobile computing device, whether the client device is disconnected from the LAN based on receiving an indication that the client device has disconnected;
performing, by the softAP mobile computing device, a look-up on a cache to obtain a link-local address of the client device in response to determining that the client device is disconnected from the LAN; and
unassigning, by the softAP mobile computing device, the prefix associated with the link-local address of the client device.

2. The method of claim 1, further comprising establishing the IPv6 WAN connection by the softAP mobile computing device, wherein the softAP mobile computing device receives a short prefix from a network resource,
wherein the pool of available prefixes is based on the short prefix.

3. The method of claim 1, further comprising routing, by the softAP mobile computing device, traffic between the WAN and the client device using the prefix when the client device is connected to the LAN.

4. The method of claim 1, wherein the indication is one of a kernel event and a hostapd user space daemon event, and wherein the indication includes at least one of a media access control (MAC) address and an IP address.

5. The method of claim 4, wherein the hostapd user space daemon event is an “AP-STA-DISCONNECTED” event, and wherein the client device is connected to the LAN via a wireless connection.

6. The method of claim 4, wherein the kernel event is an “RTM_DELLINK” kernel event, and wherein the client device is connected to the LAN via a universal serial bus (USB) connection.

7. The method of claim 4, wherein the kernel event is an “RTM_DELNEIGH” kernel event, and wherein the client device is connected to the LAN via a universal serial bus (USB) connection or a wireless connection.

8. The method of claim 1, further comprising identifying, by the softAP mobile computing device, the client device to be connected to the IPv6 WAN connection based on a received indication.

9. The method of claim 8, wherein the received indication is an “AP-STA-CONNECTED” event, and wherein the client device is requesting to connect to the LAN via a wireless connection.

10. The method of claim 8, wherein the received indication is an “RTM_NEWLINK” kernel event, and wherein the client device is requesting to connect to the LAN via a universal serial bus (USB) connection.

11. The method of claim 8, wherein the received indication is an “RTM_NEWNEIGH” kernel event, and wherein the client device is requesting to connect to the LAN via a universal serial bus (USB) connection or a wireless connection.

12. The method of claim 1, wherein the look-up is performed via an application processor of the softAP mobile computing device and the unassigning is performed via one of the application processor and a modem processor of the softAP mobile computing device.

13. The method of claim 12, further comprising transmitting, by the softAP mobile computing device via the application processor, a message to the modem processor indicating that the prefix is to be unassigned in response to performing the look-up,
wherein unassigning, by the softAP mobile computing device, the prefix associated with the link-local address of the client device comprises unassigning, by the softAP mobile computing device via the modem processor, the prefix in response to receiving the message from the application processor.

14. The method of claim 2, wherein the short prefix is 56 bits long, and each in the pool of available prefixes is 64 bits long.

15. The method of claim 1, wherein determining, by the softAP mobile computing device, whether the client device is disconnected from the LAN comprises:
determining, by the softAP mobile computing device, whether a timer has elapsed; and
testing, by the softAP mobile computing device, whether the client device is disconnected in response to determining that the timer has elapsed.

16. The method of claim 1, further comprising:
identifying, by the softAP mobile computing device, a privileged client device to be connected to the IPv6 WAN connection based on stored data indicating privileged client devices;
determining, by the softAP mobile computing device, whether there is at least one unassigned prefix in the pool of available prefixes;
determining, by the softAP mobile computing device, whether a non-privileged client device has an assigned second prefix in response to determining that there are no unassigned prefixes in the pool of available prefixes;
unassigning, by the softAP mobile computing device, the assigned second prefix in response to determining that the non-privileged client device has the assigned second prefix; and
assigning, by the softAP mobile computing device, the assigned second prefix to the privileged client device.

17. The method of claim 16, wherein the stored data indicating the privileged client devices is one or more of a list of media access control (MAC) addresses of the privileged client devices and a service set identifier (SSID) used by the privileged client devices.

18. The method of claim 16, further comprising:
adding, by the softAP mobile computing device, the identified privileged client device to a priority waiting list in response to determining that all prefixes are assigned to other devices indicated by the stored data indicating the privileged client devices;
removing, by the softAP mobile computing device, the identified privileged client device from the priority waiting list in response to unassigning one of the pool of available prefixes; and
assigning, by the softAP mobile computing device, the one of the pool of available prefixes to the identified privileged client device.

19. A mobile computing device, comprising at least one processor configured with processor-executable instructions to perform operations comprising:
assigning an unassigned prefix of a pool of available prefixes for use with an Internet Protocol version 6 (IPv6) wide area network (WAN) connection to a client device connected to a local area network (LAN) established by the mobile computing device;
determining whether the client device is disconnected from the LAN based on receiving an indication that the client device has disconnected;
performing a look-up on a cache to obtain a link-local address of the client device in response to determining that the client device is disconnected from the LAN; and
unassigning the prefix associated with the link-local address of the client device.

20. The mobile computing device of claim 19, wherein the at least one processor is configured with processor-executable instructions to perform operations further comprising:
establishing the IPv6 WAN connection,
wherein the mobile computing device receives a short prefix from a network resource, and
wherein the pool of available prefixes is based on the short prefix.

21. The mobile computing device of claim 19, wherein the at least one processor is configured with processor-executable instructions to perform operations further comprising routing traffic between the WAN and the client device using the prefix when the client device is connected to the LAN.

22. The mobile computing device of claim 19, wherein the indication is one of a kernel event and a hostapd user space daemon event, and wherein the indication includes at least one of a media access control (MAC) address and an IP address.

23. The mobile computing device of claim 19, wherein the at least one processor is configured with processor-executable instructions to perform operations further comprising identifying the client device to be connected to the IPv6 WAN connection based on a received indication.

24. The mobile computing device of claim 19, wherein:
the at least one processor comprises an application processor and a modem processor,
the look-up is performed via the application processor, and
the unassigning is performed via one of the application processor and the modem processor.

25. The mobile computing device of claim 24, wherein the at least one processor is configured with processor-executable instructions to perform operations further comprising transmitting, via the application processor, a message to the modem processor indicating that the prefix is to be unassigned in response to performing the look-up,
wherein unassigning the prefix associated with the link-local address of the client device comprises unassigning, via the modem processor, the prefix in response to receiving the message from the application processor.

26. The mobile computing device of claim 19, wherein the at least one processor is configured with processor-executable instructions to perform operations such that determining whether the client device is disconnected from the LAN comprises:
determining whether a timer has elapsed; and
testing whether the client device is disconnected in response to determining that the timer has elapsed.

27. The mobile computing device of claim 19, wherein the at least one processor is configured with processor-executable instructions to perform operations further comprising:
identifying a privileged client device to be connected to the IPv6 WAN connection based on stored data indicating privileged client devices;
determining whether there is at least one unassigned prefix in the pool of available prefixes;
determining whether a non-privileged client device has an assigned second prefix in response to determining that there are no unassigned prefixes in the pool of available prefixes;
unassigning the assigned second prefix in response to determining that the non-privileged client device has the assigned second prefix; and
assigning the assigned second prefix to the privileged client device.

28. The mobile computing device of claim 27, wherein the at least one processor is configured with processor-executable instructions to perform operations further comprising:
adding the identified privileged client device to a priority waiting list in response to determining that all prefixes are assigned to other devices indicated by the stored data indicating the privileged client devices;
removing the identified privileged client device from the priority waiting list in response to unassigning one of the pool of available prefixes; and
assigning the one of the pool of available prefixes to the identified privileged client device.

29. A mobile computing device, comprising:
means for assigning an unassigned prefix of a pool of available prefixes for an Internet Protocol version 6 (IPv6) wide area network (WAN) connection to a client device connected to a local area network (LAN) established by the mobile computing device, wherein the mobile computing device is within a prefix delegation mode;
means for determining whether the client device is disconnected from the LAN based on receiving an indication that the client device has disconnected;
means for performing a look-up on a cache to obtain a link-local address of the client device in response to determining that the client device is disconnected from the LAN; and
means for unassigning the prefix associated with the link-local address of the client device.

30. A non-transitory processor-readable storage medium having stored thereon processor-executable instructions configured to cause a processor of a mobile computing device to perform operations comprising:
assigning an unassigned prefix of a pool of available prefixes for an Internet Protocol version 6 (IPv6) wide area network (WAN) connection to a client device connected to a local area network (LAN) established by the mobile computing device, wherein the mobile computing device is within a prefix delegation mode;
determining whether the client device is disconnected from the LAN based on receiving an indication that the client device has disconnected;
performing a look-up on a cache to obtain a link-local address of the client device in response to determining that the client device is disconnected from the LAN; and
unassigning the prefix associated with the link-local address of the client device.
